(19) United States
(12) Patent Application Publication
(10) Pub. No.: US 2026/0332886 A1
(43) Pub. Date: Oct. 22, 2026

(54) IMAGE CAPTURE METHOD, ELECTRONIC DEVICE, AND NON-TRANSITORY COMPUTER-READABLE STORAGE MEDIUM

(71) Applicant: BEIJING ZITIAO NETWORK TECHNOLOGY CO., LTD., Beijing (CN)

(72) Inventors: Rong BAI, Beijing (CN); Xianqiang DUAN, Beijing (CN); Jianguo LI, Beijing (CN)

(21) Appl. No.: 19/651,577

(22) Filed: Apr. 17, 2026

(30) Foreign Application Priority Data
Apr. 18, 2025 (CN) 202510494471.0

(51) Int. Cl. H04N 23/60; H04N 23/62; H04N 23/63; H04N 23/661

(52) U.S. Cl. CPC H04N 23/64; H04N 23/62; H04N 23/632; H04N 23/633; H04N 23/661

(57) ABSTRACT

The present disclosure provides an image capture method, an electronic device, and non-transitory computer-readable storage medium. The image capture method includes: in response to a first triggering operation on a capture-control element on a first page, capturing a first image and displaying a first thumbnail of the first image on the first page; and in response to a second triggering operation on the capture-control element on the first page, capturing a second image and displaying a second thumbnail of the second image on the first page, where a position of the first thumbnail and a position of the second thumbnail do not overlap at all or partially overlap.

### CROSS-REFERENCE TO RELATED APPLICATION

This application claims the priority to and benefits of the Chinese Patent Application No. 202510494471.0, which was filed on Apr. 18, 2025. The aforementioned patent application is hereby incorporated by reference in its entirety.

### TECHNICAL FIELD

The present disclosure relates to the field of image processing technologies, and in particular, to an image capture method, an electronic device, and non-transitory computer-readable storage medium.

### BACKGROUND

Currently, many social applications have an image capture function and an image editing function. A user may use the image capture function to capture an image, and use the image editing function to edit the image and publish the edited image to a social account. In some scenarios, the user may have a need to continuously capture a plurality of images and select one image from the plurality of images for editing and posting. Therefore, how to continuously capture the plurality of images becomes one of the problems that need to be solved.

### SUMMARY

The present disclosure provides an image capture method, an electronic device, and non-transitory computer-readable storage medium which may continuously capture a plurality of images.

At least one embodiment of the present disclosure provides an image capture method, including:
capture a first image in response to a first triggering operation on a capture-control element on a first page and displaying a first thumbnail of the first image on the first page; and
capture a second image in response to a second triggering operation on the capture-control element on the first page and displaying a second thumbnail of the second image on the first page, where a position of the first thumbnail and a position of the second thumbnail do not overlap at all or partially overlap.

At least one embodiment of the present disclosure provides an image capture apparatus, including:
a first response unit configured to photograph a first image in response to a first triggering operation on a capture-control element on a first page and display a first thumbnail of the first image on the first page; and
a second response unit configured to photograph a second image in response to a second triggering operation on the capture-control element on the first page and display a second thumbnail of the second image on the first page, where a position of the first thumbnail and a position of the second thumbnail do not overlap at all or partially overlap.

At least one embodiment of the present disclosure provides an electronic device, including: one or more processor; and a memory configured to store computer-executable instructions, where the computer-executable instructions, when executed, cause the processor to implement the above image capture method.

At least one embodiment of the present disclosure provides a computer-readable storage medium configured to store computer-executable instructions, where the computer-executable instructions, when executed by a processor, implement the above image capture method.

At least one embodiment of the present disclosure provides a computer program product including a computer program, where the computer program, when executed by a processor, implements the above image capture method.

### BRIEF DESCRIPTION OF DRAWINGS

In order to more clearly describe the technical solutions in one or more embodiments of the present disclosure, the following briefly introduces the drawings that need to be used in the description of the embodiments. Obviously, the drawings in the following description are merely some embodiments recorded in the present disclosure, and for those of ordinary skill in the art, other drawings may also be obtained based on these drawings without creative efforts.

FIG. 1 is a schematic flowchart of an image capture method according to at least one embodiment of the present disclosure;

FIG. 2a is a schematic diagram of a correspondence of an image capture method according to at least one embodiment of the present disclosure;

FIG. 2b is a schematic diagram of another correspondence of an image capture method according to at least one embodiment of the present disclosure;

FIG. 3 is a schematic diagram of data flow of an image capture method according to at least one embodiment of the present disclosure;

FIG. 4 is a schematic diagram of a capture interface of a terminal device according to at least one embodiment of the present disclosure;

FIG. 5 is a structural schematic diagram of an image capture apparatus according to at least one embodiment of the present disclosure; and

FIG. 6 is a schematic diagram of a structure of an electronic device according to at least one embodiment of the present disclosure.

### DETAILED DESCRIPTION

In order for persons skilled in the art to better understand the technical solutions in one or more embodiments of the present disclosure, the technical solutions in one or more embodiments of the present disclosure are described below clearly and completely with reference to the drawings in one or more embodiments of the present disclosure. Obviously, the described embodiments are merely some rather than all of the embodiments of the present disclosure. All other embodiments obtained by persons of ordinary skill in the art based on one or more embodiments of the present disclosure without creative efforts shall fall within the scope of protection of the present disclosure.

It may be understood that before the use of the technical solutions disclosed in the embodiments of the present disclosure, the type, range of use, use scenarios, etc., of information involved in the present disclosure shall be informed to the relevant parties and the authorization of the relevant parties shall be obtained in an appropriate manner in accordance with the relevant laws and regulations.

For example, in response to reception of an active request from a user, prompt information is sent to the user to clearly inform the user that the requested operation will require access to and use of personal information of the user. As such, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may also include a selection control for the user to choose whether to "agree" or "disagree" to provide the personal information to the electronic device.

It may be understood that the above process of notifying and obtaining user authorization is only illustrative and does not constitute a limitation on the implementations of the present disclosure, and other manners that satisfy the relevant laws and regulations may also be applied in the implementations of the present disclosure.

Embodiments of the present disclosure provide an image capture method and apparatus, and a related product, which may continuously photograph a plurality of images. The image capture method may be applied to and performed by a terminal device. The terminal device includes, but is not limited to, various types of user terminals, such as a notebook computer, a tablet computer, a desktop computer, a set-top box, a mobile device (for example, a mobile phone, a portable music player, a personal digital assistant, a dedicated messaging device, or a portable game device), a smartphone, a smart speaker, a smart watch, a smart television, and a vehicle-mounted terminal.

FIG. 1 is a schematic flowchart of an image capture method according to at least one embodiment of the present disclosure. As shown in FIG. 1, the method includes steps S102 and S104.

At step S102, in response to a first triggering operation on a capture-control element on a first page, capture a first image and display a first thumbnail of the first image on the first page.

At step S104, in response to a second triggering operation on the capture-control element on the first page, capture a second image and display a second thumbnail of the second image on the first page, where a position of the first thumbnail and a position of the second thumbnail do not overlap at all or partially overlap.

In the embodiments of the present disclosure, first, in response to a first triggering operation on a capture-control element on a first page, a first image is captured and a first thumbnail of the first image is displayed on the first page; then, in response to a second triggering operation on the capture-control element on the first page, a second image is captured and a second thumbnail of the second image is displayed on the first page, where a position of the first thumbnail and a position of the second thumbnail do not overlap at all or partially overlap. It may be seen that, in the embodiments, corresponding images may be respectively captured based on a plurality of triggering operations on the capture-control element and a thumbnail of each image may be displayed, thereby achieving an effect of continuously capture a plurality of images.

In step S102, in response to a first triggering operation on a capture-control element on a first page, a first image is captured and a first thumbnail of the first image is displayed on the first page. In this embodiment, a capture application is installed and runs on a terminal device. The capture application may be a social application with an image capture function, an image editing function and an image posting function. The capture application has the first page which may be a capture page. The capture control, such as a shutter button, is displayed on the first page, and a user may touch the capture control. Based on this, the terminal device captures the first image in response to the first triggering operation of the user on the capture-control element on the first page. To be convenient for the user to preview a capture effect of the first image, the terminal device further generates the first thumbnail of the first image and displays the first thumbnail of the first image on the first page.

Similarly, in step S104, the terminal device captures a second image in response to a second triggering operation of the user on the capture-control element on the first page. To be convenient for the user to preview a capture effect of the second image, the terminal device further generates a second thumbnail of the second image and displays the second thumbnail of the second image on the first page.

The first triggering operation and the second triggering operation may be two consecutive triggering operations that occur within a short period of time, such as 1 second or 0.5 seconds, and the terminal device respectively captures the first image and the second image in response to each triggering operation. The user does not need to pay attention to whether the capture of the first image is completed before performing the second triggering operation. It may be seen that, in this embodiment, corresponding images may be respectively captured based on a plurality of triggering operations on the capture-control element and a thumbnail of each image may be displayed, thereby achieving an effect of continuously capture a plurality of images.

Furthermore, a position of the first thumbnail and a position of the second thumbnail do not overlap at all or partially overlap. For example, the first thumbnail and the second thumbnail are arranged at an interval, so that the first thumbnail and the second thumbnail do not overlap at all. Alternatively, the first thumbnail is superimposed on the second thumbnail, and the first thumbnail and the second thumbnail partially overlap. Alternatively, the second thumbnail is superimposed on the first thumbnail, and the first thumbnail and the second thumbnail partially overlap. A positional relationship between the first thumbnail and the second thumbnail may be flexibly set according to a layout of the first page.

In this embodiment, a display sequence of the first thumbnail and the second thumbnail may be the same as an acquisition sequence of the first triggering operation and the second triggering operation. For example, in response to that the first triggering operation is acquired before the second triggering operation, the first thumbnail and the second thumbnail are sequentially displayed from left to right on the first page. The user may select one image from the first image and the second image to perform a subsequent operation with reference to the first thumbnail and the second thumbnail displayed by the terminal device. For example, the user triggers the second thumbnail to select the second image, edits the second image, and posted the edited second image to the social application.

In an embodiment, the foregoing method further includes the following procedures to capture the first image and the second image.

A first capture parameter corresponding to the first triggering operation and a second capture parameter corresponding to the second triggering operation are acquired, and a plurality of camera frames captured by a camera are acquired, where the camera frames are original image data captured by the camera through an image sensor.

A first camera frame corresponding to the first capture parameter and a second camera frame corresponding to the second capture parameter are determined from the respective camera frames according to an acquisition sequence of the first triggering operation, an acquisition sequence of the second triggering operation and an acquisition sequence of the respective camera frames.

The first camera frame is processed with the first capture parameter to obtain the first image, and the second camera frame is processed with the second capture parameter to obtain the second image.

In this embodiment, the first capture parameter corresponding to the first triggering operation and the second capture parameter corresponding to the second triggering operation are acquired. Exemplarily, the first capture parameter includes, but is not limited to, at least one of the following: parameter 1 indicating whether low-light detection needs to be performed, parameter 2 indicating whether high-definition capture needs to be performed, parameter 3 indicating image size information, parameter 4 indicating image effect information, parameter 5 indicating image format information, parameter 6 indicating a rotation angle, and the like. Exemplarily, the second capture parameter includes, but is not limited to, at least one of the following: parameter 1 indicating whether low-light detection needs to be performed, parameter 2 indicating whether high-definition capture needs to be performed, parameter 3 indicating image size information, parameter 4 indicating image effect information, parameter 5 indicating image format information, parameter 6 indicating a rotation angle, and the like.

Taking the first capture parameter as an example, the low-light detection is a technology for determining whether light of a current environment is insufficient by an algorithm or a sensor, which may be used to trigger a corresponding illumination optimization measure. For example, after a flash of the terminal device is configured to an automatic working mode, the foregoing parameter 1 is set to a value indicating that the low-light detection needs to be performed. The terminal device performs low-light detection on a camera frame captured by the camera. In response to that it is determined based on a detection result that the brightness of the camera frame is too low, that is, the light of the current environment is insufficient, the flash needs to be activated and a camera frame needs to be recaptured. In response to that it is determined based on the detection result that the brightness of the camera frame is greater than a threshold, that is, the light of the current environment is sufficient, it is not necessary to activate the flash lamp and recapture the camera frame.

The high-definition capture means that a captured image needs to have a resolution higher than an expected resolution. Resolution is expressed as the number of pixels in the format "width × height", which determines how much information an image may present and directly affects clarity, detail level and file size. The expected resolution is preset by the capture application, which may be the foregoing social application. In an example, the expected resolution may be 1080 × 1920. The resolution of a camera frame captured by the camera may be 500 × 500. In response to that the parameter value of parameter 2 indicates that high-definition capture is required, the resolution of the camera frame captured by the camera needs to be changed from 500 × 500 to 1080 × 1920 by up-sampling or other means, so that the resolution of the camera frame is increased. In response to that the parameter value of parameter 2 indicates that high-definition capture is not required, the resolution of the camera frame may remain unchanged.

The image size information indicates an expected image width and an expected image height corresponding to a captured image. For example, the image size information is preset by the capture application which may be the foregoing social application. The expected image width in the image size information is w1, and the expected image height is h1. The image width of the camera frame captured by the camera is w2, and the image height is h2. The size of the camera frame is adjusted according to w1, h1, w2 and h2. The width of the adjusted camera frame is w1, and the height of the adjusted camera frame is h1. w1, h1, w2 and h2 respectively represent resolution sizes. w1 may be less than w2, and h1 may be less than h2.

The image effect refers to processing a camera frame acquired by the camera by technical means to make the processed camera frame produce a visual enhancement or artistic effect. The image effect information may indicate a processing manner used for processing the camera frame. For example, the capture application may provide various filters, stickers, beautification effects, and the like, the capture application may be the foregoing social application, and the image effect information includes, but is not limited to, at least one of the following: filter information, sticker information, beautification information, and the like.

The image format information indicates an expected image file format corresponding to the captured image. By performing format conversion on the camera frame, the format of the captured image is made to be the same as the format indicated by the image format information. Exemplarily, the image file format includes, but is not limited to, PNG (Portable Network Graphics), JPG (Joint Photographic Experts Group), and the like.

The rotation angle may indicate angle information used when performing rotation processing on the camera frame captured by the camera. For example, the rotation angle may be custom-configured or preset by the capture application, which may be the foregoing social application.

The foregoing several parameters are examples shown for ease of understanding the concept of the "first capture parameter" in the image capture method according to this embodiment. In actual application, any parameter used for processing the camera frame captured by the camera to generate an image during an image capture process may be regarded as the first capture parameter. For a specific explanation of the second capture parameter, reference may be made to the specific explanation of the first capture parameter, which is not repeated here.

In this embodiment, the terminal device may acquire a plurality of camera frames captured by the camera in response to the first triggering operation. In this embodiment, the camera frame refers to original image data captured by the camera for a to-be-photographed image through an image sensor. The camera frame is a single image and also a basic unit for image processing, transmission and storage. The image sensor is located in the camera. During a user’s single capture process, the camera frame needs to be processed according to a corresponding capture parameter to obtain an image corresponding to this capture, which is the captured image seen by the user.

In this embodiment, the first camera frame corresponding to the first capture parameter and the second camera frame corresponding to the second capture parameter are further determined from the respective camera frames according to the acquisition sequence of the first triggering operation, the acquisition sequence of the second triggering operation and the acquisition sequence of the respective camera frames. In this embodiment, the acquisition sequence of the first triggering operation is the same as the acquisition sequence of the first capture parameter, and the acquisition sequence of the second triggering operation is the same as the acquisition sequence of the second capture parameter. The first camera frame corresponding to the first capture parameter and the second camera frame corresponding to the second capture parameter may be determined from the respective camera frames according to the acquisition sequence of the first triggering operation, the acquisition sequence of the second triggering operation and the acquisition sequence of the respective camera frames in the following manner: obtaining the acquisition sequence of the first capture parameter and the acquisition sequence of the second capture parameter according to the acquisition sequence of the first triggering operation and the acquisition sequence of the second triggering operation, and obtaining the first camera frame corresponding to the first capture parameter and the second camera frame corresponding to the second capture parameter according to the acquisition sequence of the first capture parameter, the acquisition sequence of the second capture parameter and the acquisition sequence of the respective camera frames.

In this embodiment, the first camera frame is further processed with the first capture parameter, for example, resolution up-sampling processing is performed, to obtain the first image. Additionally, the second camera frame is processed with the second capture parameter, for example, an effect is added and format conversion is performed, to obtain the second image.

It may be seen that, in this embodiment, the first capture parameter corresponding to the first triggering operation and the second capture parameter corresponding to the second triggering operation may be acquired, and the plurality of camera frames captured by the camera may be acquired; the first camera frame corresponding to the first capture parameter and the second camera frame corresponding to the second capture parameter are determined from the respective camera frames according to the acquisition sequence of the first triggering operation, the acquisition sequence of the second triggering operation and the acquisition sequence of the respective camera frames; and the first camera frame is processed with the first capture parameter to obtain the first image, and the second camera frame is processed with the second capture parameter to obtain the second image. In this manner, the accuracy of the correspondence among the first capture parameter, the second capture parameter, the first camera frame and the second camera frame may be ensured, so that the generated first image precisely corresponds to the first triggering operation and the generated second image precisely corresponds to the second triggering operation.

In an embodiment, the first page is located in a capture application, and the step in which the first capture parameter corresponding to the first triggering operation and the second capture parameter corresponding to the second triggering operation are acquired includes the following steps.

The first capture parameter is determined according to first capture setup information on the first page in response to that the first triggering operation is generated and image parameter requirements corresponding to the capture application.

The second capture parameter is determined according to second capture setup information on the first page in response to that the second triggering operation is generated and the image parameter requirements.

As described above, the first page may be located in the capture application. The first page may be a capture page in the capture application. Capture setup information may be displayed on the first page. In response to that the user performs the first triggering operation on the capture-control element on the first page, the capture setup information displayed on the first page is the first capture setup information, and In response to that the user performs the second triggering operation on the capture-control element on the first page, the capture setup information displayed on the first page is the second capture setup information. The first capture setup information and the second capture setup information may be the same or different. The first capture setup information and the second capture setup information may be set by the user. The first capture setup information and the second capture setup information may be exemplified by a filter such as "fresh filter" set by the user, a beautification manner such as "retouching" set by the user, a flash working mode such as "automatic working mode" set by the user, and the like.

The image parameter requirements corresponding to the capture application may indicate requirements proposed by the capture application for each capture, where each of the foregoing captures is generated through the first page. For example, the capture application requires, for each capture, that the image format information of a finally captured image is format A. For another example, the capture application requires, for each capture, that the image size information of a finally captured image is a first size.

In this embodiment, the first capture parameter is generated according to the first capture setup information and the image parameter requirements. The first capture parameter may include a parameter in the first capture setup information and a parameter required by the image parameter requirements. The second capture parameter is generated according to the second capture setup information and the image parameter requirements. The second capture parameter may include a parameter in the second capture setup information and a parameter required by the image parameter requirements.

Taking the generation of the first capture parameter as an example, the first capture setup information includes parameter 1, which indicates that the working mode of the flash is a first working mode, and low-light detection needs to be performed in the first working mode. The first capture setup information further includes parameter 2, which carries an effect identification "001", indicating that effect information identified as 001 needs to be added to the first camera frame. The image parameter requirements include parameter 3 which represents that the format of the first camera frame needs to be converted to format A. It is then determined that the first capture parameter includes: parameter 1, parameter 2 and parameter 3.

Still taking the generation of the first capture parameter as an example, when the first capture setup information and the image parameter requirements include parameters of the same type but with different parameter values, the first capture parameter is determined according to a priority order set for parameters of this type. For example, the first capture setup information includes: parameter 1, parameter 2 and parameter 3; and the image parameter requirements include: parameter 4. Parameter 3 and parameter 4 are parameters of the same type but with different parameter values. In the priority order set for parameters of this type, the priority of the capture setup information is after the priority of the image parameter requirements, and thus parameter 3 is deleted. The first capture parameter includes: parameter 1, parameter 2 and parameter 4.

In this embodiment, a part of capture parameters provided by the capture setup information on the first page are beneficial to enriching the capture effect, and a part of capture parameters provided by the image parameter requirements corresponding to the capture application help to simplify the configuration process during the capture process and improve the convenience of the capture operations. Through comprehensive utilization of the capture setup information and the image parameter requirements, both the enrichment of the capture effect and the improvement of the convenience of the capture operation may be considered, and the capture experience may be optimized.

Taking the generation of the first capture parameter as an example, historical capture parameters corresponding to user information may also be acquired according to the user information of the user who performs the first triggering operation, and the historical capture parameters may be used as the first capture parameter. The same applies to the second capture parameter. The foregoing manners of acquiring the first capture parameter and the second capture parameter are exemplary. In the image capture method according to the embodiments of the present disclosure, the manners of acquiring the first capture parameter and the second capture parameter may be configured in combination with a specific application scenario.

In an embodiment, the step in which the plurality of camera frames captured by the camera are acquired includes the following step.

Camera frames captured by the camera at or after a first time point are acquired until the second image is obtained, where the first time point is an acquisition time point of the first triggering operation, and the camera continuously captures camera frames at a set frequency.

In this embodiment, the camera may continuously capture camera frames at a set frequency. For example, a frame rate is set to 30 fps (Frames Per Second). In this embodiment, the camera continuously captures camera frames at the set frequency on the premise that the authorization of the user is obtained.

In one case, after the user activates the image capture function of the social application, the camera starts to continuously capture camera frames at the set frequency. In another case, after the user performs the first triggering operation with the image capture function of the social application, the camera starts to continuously capture camera frames at the set frequency in response to the first triggering operation.

In this embodiment, one or more camera frames captured by the camera at or after the first time point may be acquired until the second image is obtained. Based on this, in an example, step S102 and step S104 may be performed in parallel with different threads. The second image is obtained, indicating that both the first triggering operation and the second triggering operation are processed, and there is no need to continue to acquire camera frames. Therefore, "obtaining the second image" may be used as an end condition of the step of acquiring camera frames. It may be understood that in this embodiment, the first triggering is the first acquired capture triggering, and the second triggering is the second acquired capture triggering. The first time point may be the acquisition time point of the first triggering operation or the generation time point of the first triggering operation. In actual application, the generation time and the acquisition time of the first triggering operation may be approximated to the same time point.

In the process in which the camera continuously captures camera frames at the set frequency, the camera may capture a camera frame at the first time point. In this case, the camera frame captured by the camera at the first time point may be acquired, and camera frames captured by the camera after the first time point may be acquired. The camera may not capture a camera frame at the first time point. In this case, camera frames captured by the camera after the first time point may be acquired.

In this embodiment, by acquiring the camera frames by the camera at or later the first time point until the penultimate image, it is possible to avoid the situation that the number of acquired camera frames is too small to generate the first image and the second image, thus ensuring the image capture effect.

In an embodiment, the step in which the first camera frame corresponding to the first capture parameter and the second camera frame corresponding to the second capture parameter are determined from the respective camera frames according to the acquisition sequence of the first triggering operation, the acquisition sequence of the second triggering operation and the acquisition sequence of the respective camera frames includes the following steps.

A camera frame, whose acquisition sequence is the same as the acquisition sequence of the first triggering operation, in the respective camera frames is determined as the first camera frame.

And a camera frame, whose acquisition sequence is the same as the acquisition sequence of the second triggering operation, in the respective camera frames is determined as the second camera frame.

In this embodiment, the first triggering is the first acquired capture triggering, and the second triggering is the second acquired capture triggering. Based on this, the first acquired camera frame among the respective camera frames is determined as the first camera frame, and the second acquired camera frame is determined as the second camera frame.

The first camera frame and the second camera frame are determined in the foregoing manners, so that it may be ensured that the first acquired capture triggering matches the first acquired camera frame, and the second acquired capture triggering matches the second acquired camera frame, thereby achieving a precise correspondence between the capture triggering and the camera frames.

In an embodiment, the step in which the first camera frame corresponding to the first capture parameter and the second camera frame corresponding to the second capture parameter are determined from the respective camera frames according to the acquisition sequence of the first triggering operation, the acquisition sequence of the second triggering operation and the acquisition sequence of the respective camera frames includes the following steps.

A camera frame, whose acquisition sequence is the same as the acquisition sequence of the first triggering operation, is determined from the respective camera frames. In response to that the first capture parameter indicates that the first camera frame needs to meet an image requirement, whether the determined camera frame meets the image requirement is determined; and

In response to that the image requirement is met, the determined camera frame is used as the first camera frame. In response to that the image requirement is not met, a camera frame that meets the image requirement is acquired, as the first camera frame, from among camera frames captured after a second time point, where the second time point is a capture time point of the determined camera frame.

A capture time point of the first camera frame is used as a third time point, and the second camera frame is determined from camera frames captured after the third time point, where the second triggering operation occurs later than the first triggering operation.

In this embodiment, the first triggering is the first acquired capture triggering, and the second triggering is the second acquired capture triggering. Based on this, the first acquired camera frame is determined from the respective camera frames. In response to that the first capture parameter represents that the first camera frame needs to meet the image requirement, whether the first acquired camera frame meets the image requirement is determined.

If the first acquired camera frame meets the image requirement, the first acquired camera frame is used as the first camera frame. If the first acquired camera frame does not meet the image requirement, the capture time point of the first acquired camera frame is determined as the second time point, and a camera frame that meets the image requirement is acquired, as the first camera frame, from camera frames captured after the second time point. Furthermore, the capture time point of the determined first camera frame is used as the third time point, and the second camera frame is determined from camera frames captured after the third time point.

In an example, in response to that the first capture parameter indicates that the brightness of the first camera frame needs to be greater than a brightness threshold, whether the brightness of the first acquired camera frame is greater than the brightness threshold is determined. In response to that the brightness of the first acquired camera frame is greater than the brightness threshold, the first acquired camera frame is determined as the first camera frame. The capture time point of the first camera frame is used as the third time point. In this case, the second time point and the third time point are the same. Then, the second camera frame is determined from camera frames captured after the third time point. For example, the first camera frame captured after the third time point is determined as the second camera frame.

In response to that the brightness of the first acquired camera frame is not greater than the brightness threshold, the capture time point of the first acquired camera frame is determined as the second time point, and whether the brightness of each of the camera frames captured after the second time point is greater than the brightness threshold is determined one by one, and the first detected camera frame whose brightness is greater than the brightness threshold is used as the first camera frame. Next, the capture time point of the first camera frame is used as the third time point. In this case, the second time point is earlier than the third time point. Then, the second camera frame is determined from camera frames captured after the third time point. For example, the first camera frame captured after the third time point is determined as the second camera frame.

It may be understood that the process of obtaining the second camera frame may be the same as the process of obtaining the first camera frame. Therefore, the foregoing determination process may also exist in the process of obtaining the second camera frame. For example, whether the first camera frame captured after the third time point meets the image requirement indicted by the second capture parameter is determined, and if the image requirement is met, the camera frame is determined as the second camera frame, and if the image requirement is not met, whether subsequent camera frames meet the image requirement is determined one by one, and the first detected camera frame that meets the image requirement is determined as the second camera frame.

It may be seen that, in this embodiment, when the first capture parameter requirement indicates that the first camera frame needs to meet the image requirement, a camera frame that meets the image requirement may be acquired, as the first camera frame, by detecting camera frames. Furthermore, when the second triggering operation occurs later than the first triggering operation, the second camera frame is determined from camera frames acquired after the first camera frame is acquired. In this manner, it is ensured that the first camera frame meets the requirement of the first capture parameter, and the acquisition sequence of the first camera frame and the second camera frame is the same as the acquisition sequence of the first triggering operation and the second triggering operation, thereby improving the accuracy of the correspondence between the camera frames and the capture triggering.

In an embodiment, the foregoing method further includes the following step: the first capture parameter and the second capture parameter are sequentially stored according to the acquisition sequence of the first triggering operation and the acquisition sequence of the second triggering operation.

In this embodiment, the first triggering is the first acquired capture triggering, and the second triggering is the second acquired capture triggering. Therefore, the first capture parameter may be preferentially stored, and after the first capture parameter is stored, the second capture parameter is stored. The acquisition sequence of the first triggering operation and the second triggering operation is the same as the storage sequence of the first capture parameter and the second capture parameter, thereby achieving orderly storage of the first capture parameter and the second capture parameter.

In an embodiment, the step in which the first camera frame is processed with the first capture parameter to obtain the first image, and the second camera frame is processed with the second capture parameter to obtain the second image includes the following steps.

The first capture parameter and the second capture parameter are sequentially read according to the storage sequence of the first capture parameter and the storage sequence of the second capture parameter.

The first camera frame is processed with the read first capture parameter to obtain the first image, and the second camera frame is processed with the read second capture parameter to obtain the second image.

In this embodiment, since the reading sequence of the first capture parameter and the second capture parameter is the same as the storage sequence of the first capture parameter and the second capture parameter, and the storage sequence of the first capture parameter and the second capture parameter is the same as the acquisition sequence of the first triggering operation and the second triggering operation, the reading sequence of the first capture parameter and the second capture parameter is the same as the acquisition sequence of the first triggering operation and the second triggering operation. This is beneficial to achieving that the first acquired capture triggering is processed first and the second acquired capture triggering is processed later, and orderly and continuous capture of a plurality of images may be achieved.

Exemplarily, the steps of this implementation may be implemented with a data structure "queue" or other data structures with a first-in-first-out feature. The queue is a linear data structure that follows the principle of first-in-first-out principle. Elements that first enter the queue are preferentially processed, and elements that enter later need to wait.

For example, a storage area is set, and the storage area adopts a queue data structure, which may be denoted as Queue 1. The first capture parameter and the second capture parameter are sequentially added to the rear of Queue 1 according to the acquisition sequence of the first triggering operation and the acquisition sequence of the second triggering operation. when a camera frame captured by the camera is acquired, whether the storage area is empty may be first determined. In response to that the storage area is empty, it indicates that there is no capture parameters to be processed, that is, there is no capture triggering to be processed. In response to that the storage area is not empty, a capture parameter is retrieved from the front of Queue 1, and the camera frame captured by the camera is processed with the capture parameter to obtain an image corresponding to the capture triggering.

In this embodiment, the first capture parameter and the second capture parameter are sequentially read according to the storage sequence of the first capture parameter and the second capture parameter. The first camera frame is processed with the read first capture parameter to obtain the first image, and the second camera frame is processed with the read second capture parameter to obtain the second image. In this manner, the accuracy of the correspondence among the first capture parameter, the second capture parameter, the first camera frame and the second camera frame may be ensured, so that each generated image precisely corresponds to each capture triggering.

In this embodiment, in the process in which the first camera frame is processed with the first capture parameter to obtain the first image, and the second camera frame is processed with the second capture parameter to obtain the second image, the first capture parameter may include one or more of the foregoing parameters, and the second capture parameter may include one or more of the foregoing parameters. Each parameter has a corresponding image processing manner, and several image processing manners are exemplified below.
(1) When a parameter includes the image size information, processing the corresponding camera frame with the parameter may involve adjusting the resolution of the camera frame to the same resolution as indicated by the image size information.
(2) When that the parameter includes the effect information, processing the corresponding camera frame with the parameter may involve adding an effect to the camera frame according to the effect information.
(3) When the parameter includes the rotation angle, processing the corresponding camera frame with the parameter may involve rotating the camera frame according to the rotation angle.
(4) When the parameter includes the image file format, processing the corresponding camera frame with the parameter may involve encoding the camera frame according to an encoding manner corresponding to the image file format.

In actual application, the image processing manner corresponding to each capture parameter may be configured in combination with a specific application scenario.

In the foregoing process, taking the first triggering operation and the second triggering operation as an example, the process of continuous capturing twice and acquiring the first image and the second image is introduced. It may be understood that based on the foregoing technical concept, continuous capturing for three times or more may be achieved, which will be described below.

In an embodiment, the foregoing method flow further includes the following steps.

A plurality of capture triggering and capture parameters corresponding to the capture triggering are acquired, and a plurality of camera frames captured by a camera are acquired.

A correspondence between the capture parameters and the camera frames is determined according to an acquisition sequence of the capture triggering and an acquisition sequence of the camera frames.

Based on the correspondence, the corresponding camera frames are processed with the capture parameters, and the processed camera frames become images captured based on the capture triggering.

A plurality of continuous capture triggering operations on the capture-control element on the first page may be acquired. The capture parameter corresponding to each capture triggering is acquired with the method introduced above. A plurality of camera frames captured by the camera at or after a specified time point are acquired with the method introduced above, where the specified time point is the acquisition time point of the first capture triggering.

Furthermore, the correspondence between the capture parameters and the camera frames is determined according to the acquisition sequence of the capture triggering and the acquisition sequence of the camera frames. In an embodiment, the step in which the correspondence between the capture parameters and the camera frames is determined according to the acquisition sequence of the capture triggering and the acquisition sequence of the camera frames includes the following steps: one capture triggering is determined from the respective capture triggering, one camera frame is determined from the respective camera frames, an acquisition sequence ranking of the capture triggering among the respective capture triggering is equal to an acquisition sequence ranking of the camera frame among the respective camera frames, and a capture parameter corresponding to the capture triggering is determined as a capture parameter corresponding to the camera frame.

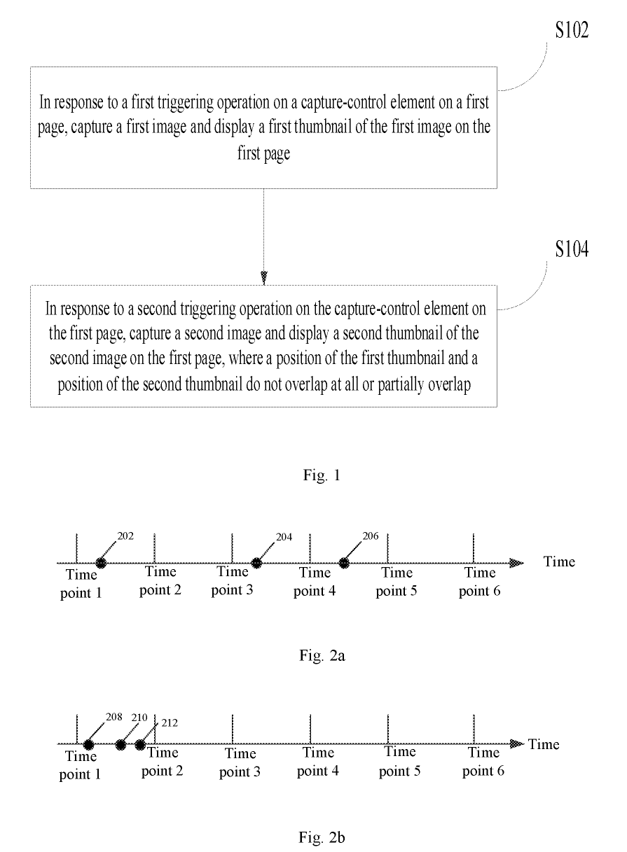

FIG. 2a is a schematic diagram of a correspondence in an image capture method according to at least one embodiment of the present disclosure. FIG. 2a exemplarily shows a correspondence between capture triggering and camera frames when a camera continuously captures camera frames at a set frequency during the execution of the image capture method according to the embodiments of the present disclosure.

As shown in FIG. 2a, the camera continuously captures camera frames at the set frequency. Specifically, the camera captures a camera frame 1 at time point 1, a camera frame 2 at time point 2, ..., and a camera frame 6 at time point 6. The time point 1, time point 2, ..., time point 6 are sequentially arranged from first to last in chronological order, with equal time intervals between adjacent time points.

An acquisition time point of a capture triggering 202 falls between time point 1 and time point 2, an acquisition time point of a capture triggering 204 falls between Time point 3 and time point 4, and an acquisition time point of a capture triggering 206 falls between time point 4 and time point 5.

In the scenario shown in FIG. 2a, there is a correspondence between the capture parameter corresponding to the capture triggering 202 and the camera frame 2, between the capture parameter corresponding to the capture triggering 204 and the camera frame 4, and between the capture parameter corresponding to the capture triggering 206 and the camera frame 5.

FIG. 2b is a schematic diagram of another correspondence in an image capture method according to at least one embodiment of the present disclosure. FIG. 2b exemplarily shows another correspondence between capture triggering and camera frames when a camera continuously captures camera frames at a set frequency during the execution of the image capture method according to the embodiments of the present disclosure.

As shown in FIG. 2b, the camera continuously captures camera frames at the set frequency. Specifically, the camera captures a camera frame 1 at time point 1, a camera frame 2 at time point 2, ..., and a camera frame 6 at time point 6. The time point 1, time point 2, ..., time point 6 are sequentially arranged from first to last in chronological order, with equal time intervals between adjacent time points.

An acquisition time point of a capture triggering 208 falls between time point 1 and time point 2, an acquisition time point of a capture triggering 210 falls between time point 1 and time point 2, and an acquisition time point of a capture triggering 212 falls between time point 1 and time point 2.

In the scenario shown in FIG. 2b, the capture triggering 208 is the first acquired capture triggering, and the capture triggering 212 is the last acquired capture triggering. When sorted in chronological order from first to last, exemplarily, the acquisition sequence of the capture triggering may be expressed as: the capture triggering 208, the capture triggering 210, and the capture triggering 212, and the acquisition sequence of the camera frames may be expressed as: the camera frame 2, the camera frame 3, and the camera frame 4. There is a correspondence between a capture parameter corresponding to the capture triggering 208 and the camera frame 2, between a capture parameter corresponding to the capture triggering 210 and the camera frame 3, and between a capture parameter corresponding to the capture triggering 212 and the camera frame 4.

In an embodiment, the step in which the correspondence between the capture parameters and the camera frames is determined according to the acquisition sequence of the capture triggering and the acquisition sequence of the camera frames includes the following steps: a capture triggering 1 is determined from the respective capture triggering, a camera frame 1 is determined from the respective camera frames, an acquisition sequence ranking of the capture triggering 1 among the respective capture triggering is equal to an acquisition sequence ranking of the camera frame 1 among the respective camera frames. In response to that the capture parameter corresponding to the capture triggering 1 indicates that a camera frame corresponding to the capture parameter needs to meet an image requirement, whether the camera frame 1 meets the image requirement is determined. In response to that the camera frame 1 meets the image requirement, the camera frame 1 is taken as the camera frame corresponding to the capture parameter of the capture triggering 1, and in response to that the camera frame 1 does not meet the image requirement, the camera frame 1 is discarded, and a camera frame corresponding to the capture parameter of the capture triggering 1 is determined from camera frames acquired after a specific time point, where the specific time point is a capture time point of the aforesaid camera frame 1.

In this embodiment, after the camera frame corresponding to the capture triggering 1 is determined, the camera frame corresponding to the capture parameter of each capture triggering acquired after the capture triggering 1 is determined from each camera frame acquired after the camera frame. The determination here may be made according to the acquisition sequence of the respective capture triggering and the acquisition sequence of the respective camera frames.

The specific implementation process of this implementation may be exemplarily described below in combination with FIG. 2b. As shown in FIG. 2b, the capture triggering 208 is the first acquired capture triggering, and the capture triggering 212 is the last acquired capture triggering. When sorted in chronological order from first to last, exemplarily, the acquisition sequence of the capture triggering may be represented as: the capture triggering 208, the capture triggering 210, and the capture triggering 212, and the acquisition sequence of the camera frames may be represented as: the camera frame 2 acquired at the time point 2, the camera frame 3 acquired at the time point 3, and the camera frame 4 acquired at the time point 4.

It may be determined according to the acquisition sequence of the respective capture triggering and the acquisition sequence of the respective camera frames that: there is a correspondence between the capture triggering 208 and the camera frame 2; there is a correspondence between the capture triggering 210 and the camera frame 3; and there is a correspondence between the capture triggering 212 and the camera frame 4. The capture parameter corresponding to the capture triggering 208 includes: parameter 1 indicating that low-light detection needs to be performed. The camera frame corresponding to the parameter 1 needs to meet the following image requirement: brightness information is greater than a specified brightness threshold.

Based on this, whether the brightness information of the camera frame 2 is greater than the specified brightness threshold is determined. In response to that the camera frame 2 does not meet that the brightness information is greater than the specified brightness threshold, the camera frame 2 is discarded, the camera frame 3 is acquired, and whether the camera frame 3 meets that the brightness information is greater than the specified brightness threshold is determined. In response to that the camera frame 3 does not meet that the brightness information is greater than the specified brightness threshold, the camera frame 3 is discarded, the camera frame 4 is acquired, and whether the camera frame 4 meets that the brightness information is greater than the specified brightness threshold is determined. In response to that the camera frame 4 meets that the brightness information is greater than the specified brightness threshold, the camera frame 4 is taken as the camera frame corresponding to the capture parameter of the capture triggering 208, that is, the capture parameter corresponding to the capture triggering 208 corresponds to the camera frame 4.

Next, a camera frame 5 captured at the time point 5, a camera frame 6 captured at the time point 6, and the like are acquired. It is determined that a capture parameter corresponding to the capture triggering 210 corresponds to the camera frame 5, and a capture parameter corresponding to the capture triggering 212 corresponds to the camera frame 6.

To sum up, the obtained correspondence between the capture parameters and the camera frames is as follows: there is a correspondence between the capture parameter corresponding to the capture triggering 208 and the camera frame 4, there is a correspondence between the capture parameter corresponding to the capture triggering 210 and the camera frame 5, and there is a correspondence between the capture parameter corresponding to the capture triggering 212 and the camera frame 6.

It may be seen that in this embodiment, it may be achieved that the first acquired capture triggering is processed first and the capture triggering acquired later is processed later, enabling the orderly and continuous capture of a plurality of images.

In this embodiment, capture parameters corresponding to the capture triggering may be sequentially stored according to the acquisition sequence of the capture triggering, the capture parameters may be sequentially read according to the storage sequence, and for the read capture parameter, the corresponding camera frame is processed with the read capture parameter.

In this embodiment, a display sequence of thumbnails of the respective images may be determined according to the acquisition sequence of the capture triggering, and the display sequence is used for sequentially displaying the thumbnails of the respective images on the terminal device. For example, the capture triggering 1 corresponds to the image 1, the capture triggering 2 corresponds to the image 2, and the capture triggering 3 corresponds to the image 3. The acquisition sequence of the respective capture triggering from first to last is: the capture triggering 1, the capture triggering 2, and the capture triggering 3, and the display sequence of the thumbnails of the respective images from first to last is: the image 1, the image 2, and the image 3. Furthermore, the terminal device may sequentially display the thumbnail of the image 1, the thumbnail of the image 2 and the thumbnail of the image 3 from left to right according to the display sequence.

It may be seen that, through the foregoing embodiments, when three or more capture triggering of the user on the capture-control element are acquired, the image corresponding to each capture triggering may be generated, thereby achieving continuous capture of a plurality of images.

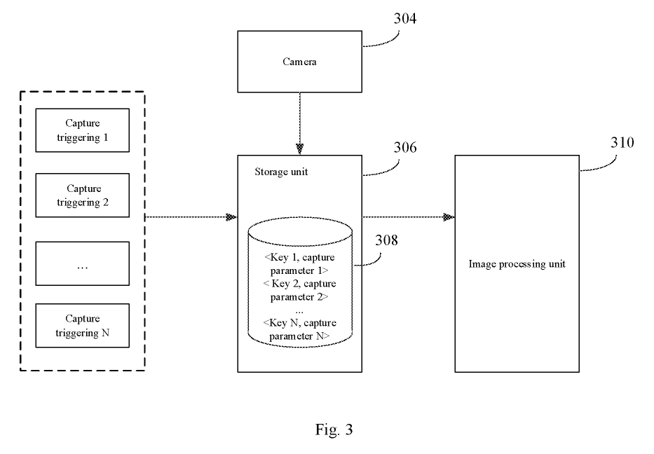

FIG. 3 is a schematic diagram of a data flow in an image capture method according to at least one embodiment of the present disclosure. The image capture method may be applied to a terminal device, and the terminal device shown in FIG. 3 at least includes the following structures: a camera 304, a storage unit 306 and an image processing unit 308.

As shown in FIG. 3, a capture triggering may have a corresponding capture parameter, and the capture parameter corresponding to each capture triggering is transmitted to the storage unit 306. For the acquisition process of the capture triggering, reference may be made to the foregoing description, and for the process of transmitting the capture parameter corresponding to each capture triggering to the storage unit 306, reference may be made to the foregoing description. The camera 304 may capture camera frames at a set frame rate and transmit the captured camera frames to the storage unit 306. For the process of transmitting the camera frames by the camera 304 to the storage unit 306, reference may be made to the foregoing description.

The storage unit 306 may orderly store the capture parameters corresponding to the respective capture triggering in the form of a queue and achieve orderly reading of the capture parameters. For example, the capture parameters corresponding to the capture triggering are sequentially stored according to the acquisition sequence of the capture triggering, and the capture parameters are sequentially read according to the storage sequence of the capture parameters.

In addition to storing the capture parameters corresponding to each capture triggering, the storage unit 306 may further store an acquisition time point of each capture triggering, and use the acquisition time point as a key. For each capture triggering, the capture parameter corresponding to the capture triggering may be marked with the key. The storage unit 306 may add the capture parameter carrying the key mark to a mapping table 308. By marking the capture parameter, the uniqueness of each capture triggering may be determined.

As shown in FIG. 3, the mapping table 308 includes: (key 1, capture parameter 1), (key 2, capture parameter 2), and the like. The capture parameter 1 is a capture parameter corresponding to one capture triggering, and the key 1 may be the acquisition time point of the "one capture triggering". The capture parameter 2 is a capture parameter corresponding to another capture triggering, and the key 2 may be the acquisition time point of the "another capture triggering".

The storage unit 306 may further receive each camera frame captured by the camera 304. Furthermore, the terminal device may use each capture parameter stored in the mapping table 308 in the storage unit 306 and each camera frame received by the storage unit 306 to perform the step of obtaining the correspondence between the capture parameters and the camera frames according to the acquisition sequence of the capture triggering and the acquisition sequence of the camera frames.

After obtaining the correspondence between the capture parameters and the camera frames, the terminal device may transmit the capture parameters and the camera frames from the storage unit 306 to the image processing unit 310. The image processing unit 310 is configured to process the corresponding camera frames with the capture parameters based on the correspondence, and the processed camera frames become image data obtained based on the corresponding capture triggering.

Since the concept is the same, the embodiments of the present disclosure are described briefly and may be referred to the corresponding description above. In FIG. 3, N is a positive integer greater than 2.

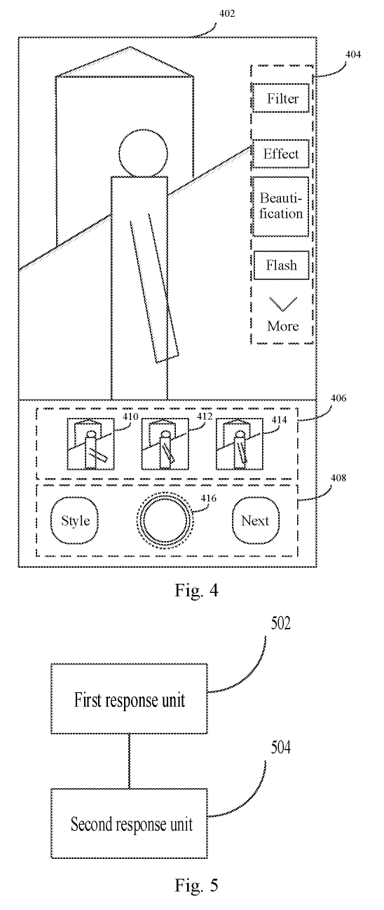

FIG. 4 is a schematic diagram of a capture interface of a terminal device according to at least one embodiment of the present disclosure. The foregoing social application runs on the terminal device. The capture interface (that is, the first page) of the social application provides a filter, an effect, beautification, and the like, and the social application has corresponding image parameter requirements determined in advance.

As shown in FIG. 4, the capture interface of the capture application on the terminal device at least includes: a framing area 402, a first operation area 404, a display area 406, a second operation area 408, and the like. The framing area 402 displays a to-be-captured image. The first operation area 404 includes a filter setting control, an effect setting control, a beautification setting control, a flash setting control, and the like. The display area 406 is used for displaying a thumbnail 410, a thumbnail 412 and a thumbnail 414. The second operation area 408 includes a shutter control 416, and the like.

As shown in FIG. 4, through the foregoing embodiments, the user may touch the shutter control 416 multiple times consecutively, and the terminal device obtains a corresponding image by capture for each triggering and sequentially displays the thumbnail of each image on the capture interface according to the generation sequence (that is, the acquisition sequence) of each capture triggering.

Since the concept is the same, the embodiments of the present disclosure are described briefly and may be referred to the corresponding description above. The ordinal numbers such as first and second in this specification are for ease of distinguishing different technical features and have no practical meaning.

At least one embodiment of the present disclosure further provides an image capture apparatus, and FIG. 5 is a structural schematic diagram of an image capture apparatus according to at least one embodiment of the present disclosure. As shown in FIG. 5, the image capture apparatus includes a first response unit 502 and a second response unit 504.

The first response unit 502 is configured to capture a first image and display a first thumbnail of the first image on the first page in response to a first triggering operation on a capture-control element on a first page.

The second response unit 504 is configured to capture a second image and display a second thumbnail of the second image on the first page in response to a second triggering operation on the capture-control element on the first page, where a position of the first thumbnail and a position of the second thumbnail do not overlap at all or partially overlap.

Optionally, the apparatus further includes an image generation unit configured to: acquire a first capture parameter corresponding to the first triggering operation and a second capture parameter corresponding to the second triggering operation, and acquire a plurality of camera frames captured by a camera, where the camera frames are original image data captured by the camera through an image sensor; determine a first camera frame corresponding to the first capture parameter and a second camera frame corresponding to the second capture parameter from the respective camera frames according to an acquisition sequence of the first triggering operation, an acquisition sequence of the second triggering operation and an acquisition sequence of the respective camera frames; and process the first camera frame with the first capture parameter to obtain the first image, and process the second camera frame with the second capture parameter to obtain the second image.

Optionally, the image generation unit is further configured to: determine the first capture parameter according to first capture setup information on the first page in response to generating the first triggering operation and image parameter requirements corresponding to the capture application; and determine the second capture parameter according to second capture setup information on the first page in response to generating the second triggering operation and the image parameter requirements.

Optionally, the image generation unit is further configured to: acquire the camera frames captured by the camera at or after a first time point until the second image is obtained, where the first time point is an acquisition time point of the first triggering operation, and the camera continuously captures the camera frames at a set frequency.

Optionally, the image generation unit is further configured to: determine a camera frame, whose acquisition sequence is the same as the acquisition sequence of the first triggering operation, as the first camera frame from the respective camera frames,; and determine a camera frame, whose acquisition sequence is the same as the acquisition sequence of the second triggering operation, as the second camera frame from the respective camera frames.

Optionally, the image generation unit is further configured to: determine, from the respective camera frames, a camera frame whose acquisition sequence is the same as the acquisition sequence of the first triggering operation, and in response to the first capture parameter indicates that the first camera frame needs to meet an image requirement, determine whether the determined camera frame meets the image requirement; in response to that the camera frame determined meets the image requirement, use the determined camera frame as the first camera frame, and in response to that the camera frame determined does not meet the image requirement, acquire, as the first camera frame, a camera frame that meets the image requirement from camera frames captured after a second time point, where the second time point is a capture time point of the determined camera frame; and use a capture time point of the first camera frame as a third time point, and determine the second camera frame from camera frames captured after the third time point, where the second triggering operation occurs later than the first triggering operation.

Optionally, the apparatus further includes a sequence storage unit configured to: sequentially store the first capture parameter and the second capture parameter according to the acquisition sequence of the first triggering operation and the acquisition sequence of the second triggering operation.

Optionally, the image generation unit is further configured to: sequentially read the first capture parameter and the second capture parameter according to a storage sequence of the first capture parameter and a storage sequence of the second capture parameter; and process the first camera frame with the read first capture parameter to obtain the first image, and process the second camera frame with the read second capture parameter to obtain the second image.

Through this embodiment, first, a first image is captured and a first thumbnail of the first image is displayed on the first page, in response to a first triggering operation on a capture-control element on a first page; then, a second image is captured and a second thumbnail of the second image is displayed on the first page, in response to a second triggering operation on the capture-control element on the first page, where a position of the first thumbnail and a position of the second thumbnail do not overlap at all or partially overlap. It may be seen that, through this embodiment, corresponding images may be respectively captured based on a plurality of triggering operations on the capture-control element and a thumbnail of each image may be displayed, thereby achieving an effect of continuously capturing a plurality of images.

The image capture apparatus in the embodiments of the present disclosure may implement each process of the above image capture method embodiments and achieve the same effects and functions, which will not be repeated here.

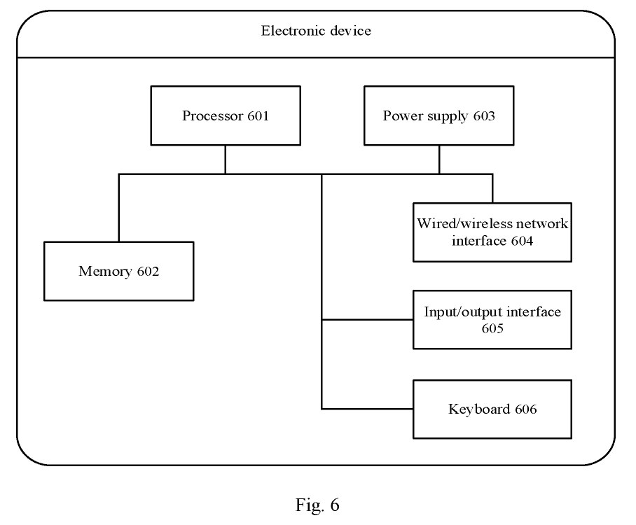

An embodiment of the present disclosure further provides an electronic device. FIG. 6 is a schematic diagram of a structure of an electronic device according to an embodiment of the present disclosure. As shown in FIG. 6, the electronic device may vary greatly due to different configurations or performances, and may include one or more processors 601 and memories 602, and one or more applications or data may be stored in the memory 602. The memory 602 may be a temporary memory or a persistent memory. The applications stored in the memory 602 may include one or more modules (not shown), and each module may include a series of computer-executable instructions in the electronic device. Furthermore, the processor 601 may be configured to communicate with the memory 602 and execute a series of computer-executable instructions in the memory 602 on the electronic device. The electronic device may further include one or more power supplies 603, one or more wired or wireless network interfaces 604, one or more input or output interfaces 605, one or more keyboards 606, and the like.

In a specific embodiment, the electronic device includes a processor, and a memory configured to store computer-executable instructions, where the computer-executable instructions, when executed, cause the processor to implement the following processes:
in response to a first triggering operation on a capture-control element on a first page, capture a first image and display a first thumbnail of the first image on the first page; and
in response to a second triggering operation on the capture-control element on the first page, capture a second image and display a second thumbnail of the second image on the first page, where a position of the first thumbnail and a position of the second thumbnail do not overlap at all or partially overlap.

Through this embodiment, first, a first image is captured and a first thumbnail of the first image is displayed on the first page, in response to a first triggering operation on a capture-control element on a first page; then, a second image is captured and a second thumbnail of the second image is displayed on the first page, in response to a second triggering operation on the capture-control element on the first page, where a position of the first thumbnail and a position of the second thumbnail do not overlap at all or partially overlap. It may be seen that, in this embodiment, corresponding images may be respectively captured based on a plurality of triggering operations on the capture-control element and a thumbnail of each image may be displayed, thereby achieving an effect of continuously capturing a plurality of images.

The electronic device in the embodiments of the present disclosure may implement each process of the above image capture method embodiments and achieve the same effects and functions, which will not be repeated here.

Another embodiment of the present disclosure further provides a computer-readable storage medium configured to store computer-executable instructions, where the computer-executable instructions, when executed by a processor, implement the following processes:
capture a first image and display a first thumbnail of the first image on the first page, in response to a first triggering operation on a capture-control element on a first page; and
capture a second image and display a second thumbnail of the second image on the first page, in response to a second triggering operation on the capture-control element on the first page, where a position of the first thumbnail and a position of the second thumbnail do not overlap at all or partially overlap.

Through this embodiment, first, a first image is captured and a first thumbnail of the first image is displayed on the first page, in response to a first triggering operation on a capture-control element on a first page; then, a second image is captured and a second thumbnail of the second image is displayed on the first page, in response to a second triggering operation on the capture-control element on the first page, where a position of the first thumbnail and a position of the second thumbnail do not overlap at all or partially overlap. It may be seen that, in this embodiment, corresponding images may be respectively captured based on a plurality of triggering operations on the capture-control element and a thumbnail of each image may be displayed, thereby achieving an effect of continuously capturing a plurality of images.

The computer-readable storage medium in the embodiments of the present disclosure may implement each process of the above image capture method embodiments and achieve the same effects and functions, which will not be repeated here.

Another embodiment of the present disclosure further provides a computer program product including a computer program, where the computer program, when executed by a processor, implements the following processes:
capture a first image and display a first thumbnail of the first image on the first page, in response to a first triggering operation on a capture-control element on a first page; and
capture a second image and display a second thumbnail of the second image on the first page, in response to a second triggering operation on the capture-control element on the first page, where a position of the first thumbnail and a position of the second thumbnail do not overlap at all or partially overlap.

Through this embodiment, first, a first image is captured and a first thumbnail of the first image is displayed on the first page, in response to a first triggering operation on a capture-control element on a first page; then, a second image is captured and a second thumbnail of the second image is displayed on the first page, in response to a second triggering operation on the capture-control element on the first page, where a position of the first thumbnail and a position of the second thumbnail do not overlap at all or partially overlap. It may be seen that, in this embodiment, corresponding images may be respectively captured based on a plurality of triggering operations on the capture-control element and a thumbnail of each image may be displayed, thereby achieving an effect of continuously capturing a plurality of images.

The computer program product in the embodiments of the present disclosure may implement each process of the above image capture method embodiments and achieve the same effects and functions, which will not be repeated here.

In the various embodiments of the present disclosure, the computer-readable storage medium includes a read-only memory (abbreviated as ROM), a random access memory (abbreviated as RAM), a magnetic disk, an optical disk, or the like.

In the 1990s, an improvement on a technology may be clearly distinguished as a hardware improvement (for example, an improvement on a circuit structure of a diode, a transistor, a switch, or the like) or a software improvement (an improvement on a method flow). However, with the development of technologies, many improvements on method flows today may be regarded as direct improvements on hardware circuit structures. Designers almost all program improved method flows into hardware circuits to obtain corresponding hardware circuit structures. Therefore, it cannot be said that an improvement on a method flow cannot be implemented with a hardware entity module. For example, a programmable logic device (abbreviated as PLD) (for example, a field programmable gate array (abbreviated as FPGA)) is such an integrated circuit, whose logic function is determined by a user by programming the device. Instead of asking a chip manufacturer to design and manufacture a dedicated integrated circuit chip, a designer may program on his or her own to "integrate" a digital system on a PLD. Moreover, today, instead of manually manufacturing an integrated circuit chip, this programming is mostly implemented with "logic compiler" software, which is similar to the software compiler used in program development and writing, and the original code before compilation also needs to be written in a specific programming language, which is called a hardware description language (abbreviated as HDL). There is not only one type of HDL, but many types, such as advanced boolean expression language (ABEL), altera hardware description language (AHDL), confluence, Cornell university programming language (CUPL), HDCal, Java hardware description language (JHDL), lava, lola, MyHDL, PALASM, ruby hardware description language (RHDL), etc. Currently, the most commonly used are very-high-speed integrated circuit hardware description language (VHDL) and Verilog. It should also be clear to persons skilled in the art that a hardware circuit for implementing a logic method flow may be easily obtained by simply performing logic programming on the method flow in the foregoing several hardware description languages and programming the method flow into an integrated circuit.

The controller may be implemented in any suitable manner, for example, the controller may be in the form of a microprocessor or a processor, a computer-readable medium storing computer-readable program code (such as software or firmware) executable by the (micro)processor, a logic gate, a switch, an application specific integrated circuit (abbreviated as ASIC), a programmable logic controller, and an embedded microcontroller. Examples of the controller include, but are not limited to, the following microcontrollers: ARC 625D, Atmel AT91SAM, Microchip PIC18F26K20, and Silicone Labs C8051F320. The memory controller may also be implemented as a part of control logic of the memory. Persons skilled in the art also know that in addition to implementing the controller in a pure computer-readable program code manner, it is entirely possible to perform logic programming on method steps to enable the controller to implement the same functions in the form of a logic gate, a switch, a dedicated integrated circuit, a programmable logic controller, an embedded microcontroller, and the like. Therefore, such a controller may be considered as a hardware component, and an apparatus included therein for implementing various functions may also be considered as a structure within the hardware component. Alternatively, the apparatus for implementing various functions may even be considered as both a software module for implementing the method and a structure within the hardware component.

The system, apparatus, module or unit illustrated in the foregoing embodiments may be implemented specifically by a computer chip or entity, or by a product with a specific function. A typical implementation device is a computer. Specifically, the computer may be, for example, a personal computer, a laptop computer, a cellular phone, a camera phone, a smart phone, a personal digital assistant, a media player, a navigation device, an email device, a game console, a tablet computer, a wearable device, or a combination of any of these devices.

For ease of description, when described, the above apparatus is divided into various units based on functions. Certainly, when the embodiments of the present disclosure are implemented, the functions of the units may be implemented in the same one or more pieces of software and/or hardware.

Persons skilled in the art should understand that one or more embodiments of the present disclosure may be provided as a method, a system, or a computer program product. Therefore, one or more embodiments of the present disclosure may take the form of an entirely hardware embodiment, an entirely software embodiment, or an embodiment containing both hardware and software elements. Furthermore, one or more embodiments of the present disclosure may take the form of a computer program product implemented on one or more computer-usable storage media (including, but not limited to, a disk memory, a CD-ROM, an optical memory, etc.) having computer-usable program code embodied therein.

The present disclosure is described with reference to flowcharts and/or block diagrams of a method, a device (system), and a computer program product according to embodiments of the present disclosure. It should be understood that each process and/or block in the flowcharts and/or block diagrams, and a combination of processes and/or blocks in the flowcharts and/or block diagrams may be implemented by computer program instructions. These computer program instructions may be provided to a processor of a general-purpose computer, a special-purpose computer, an embedded processor, or other programmable data processing device to produce a machine, such that the instructions, when executed by the processor of the computer or other programmable data processing device, produce an apparatus for implementing a specific function in one or more processes in the flowcharts and/or in one or more blocks in the block diagrams.

These computer program instructions may also be stored in a computer-readable memory that may direct the computer or other programmable data processing device to work in a specific manner, such that the instructions stored in the computer-readable memory produce a manufactured product including an instruction apparatus, where the instruction apparatus implements a specific function in one or more processes in the flowcharts and/or in one or more blocks in the block diagrams.

These computer program instructions may also be loaded onto the computer or other programmable data processing device, such that a series of operations and steps are performed on the computer or other programmable device to produce computer-implemented processing, and thus the instructions executed on the computer or other programmable device provide steps for implementing a specific function in one or more processes in the flowcharts and/or in one or more blocks in the block diagrams.

It should also be noted that the terms "include", "include", or any other variation thereof are intended to cover non-exclusive inclusion, such that a process, method, product, or device that includes a series of elements includes not only those elements, but also other elements not expressly listed or elements inherent to such process, method, product, or device. Without further limitation, an element defined by the phrase "includes a" does not exclude the presence of additional identical elements in the process, method, product, or device that includes the element.

One or more embodiments of the present disclosure may be described in the general context of computer-executable instructions, such as program modules, executed by a computer. Generally, the program modules include routines, programs, objects, components, data structures, etc. that perform specific tasks or implement specific abstract data types. One or more embodiments of the present disclosure may also be practiced in distributed computing environments, in which tasks are performed by remote processing devices connected through a communication network. In the distributed computing environments, the program modules may be located in local and remote computer storage media including storage devices.

The embodiments of the present disclosure are all described in a progressive manner, and for the same and similar parts among the embodiments, reference may be made to each other, and each embodiment focuses on the differences from other embodiments. In particular, the system embodiment is relatively briefly described because it is basically similar to the method embodiment, and for related parts, reference may be made to the description of the method embodiment.

The above description illustrates merely embodiments of the present disclosure and is not intended to limit the present disclosure. For persons skilled in the art, the present disclosure may have various modifications and changes. Any modification, equivalent replacement, improvement, etc. made within the spirit and principles of the present disclosure shall fall within the scope of the claims of the present disclosure.

1. An image capture method, comprising:
in response to a first triggering operation on a capture-control element on a first page, capturing a first image and displaying a first thumbnail of the first image on the first page; and
in response to a second triggering operation on the capture-control element on the first page, capturing a second image and displaying a second thumbnail of the second image on the first page, wherein a position of the first thumbnail and a position of the second thumbnail do not overlap at all or partially overlap.

2. The image capture method of claim 1, further comprising:
acquiring a first capture parameter corresponding to the first triggering operation and a second capture parameter corresponding to the second triggering operation, and acquiring a plurality of camera frames captured by a camera, wherein the camera frames are original image data captured by the camera through an image sensor;
obtaining a first camera frame corresponding to the first capture parameter and a second camera frame corresponding to the second capture parameter from the camera frames according to an acquisition sequence of the first triggering operation, an acquisition sequence of the second triggering operation and an acquisition sequence of the camera frames; and
processing the first camera frame with the first capture parameter to obtain the first image, and processing the second camera frame with the second capture parameter to obtain the second image.

3. The image capture method of claim 2, wherein the first page is located in a capture application, and the acquiring a first capture parameter corresponding to the first triggering operation and a second capture parameter corresponding to the second triggering operation, comprises:
obtaining the first capture parameter according to first capture setup information on the first page in response to generating the first triggering operation as well as image parameter requirements corresponding to the capture application; and
obtaining the second capture parameter according to second capture setup information on the first page in response generating the second triggering operation as well as the image parameter requirements.

4. The image capture method of claim 2, wherein the acquiring a plurality of camera frames captured by a camera, comprises:
acquiring the camera frames captured by the camera at or after a first time point until the second image is obtained, wherein the first time point is an acquisition time point of the first triggering operation, and the camera continuously captures the camera frames at a set frequency.

5. The image capture method of claim 2, wherein the obtaining a first camera frame corresponding to the first capture parameter and a second camera frame corresponding to the second capture parameter from the camera frames according to an acquisition sequence of the first triggering operation, an acquisition sequence of the second triggering operation and an acquisition sequence of the respective camera frames, comprises:
obtaining a camera frame, whose acquisition sequence is the same as the acquisition sequence of the first triggering operation as the first camera frame from the camera frames; and
obtaining a camera frame, whose acquisition sequence is the same as the acquisition sequence of the second triggering operation as the second camera frame from the camera frames.

6. The image capture method of claim 2, wherein the obtaining a first camera frame corresponding to the first capture parameter and a second camera frame corresponding to the second capture parameter from the camera frames according to an acquisition sequence of the first triggering operation, an acquisition sequence of the second triggering operation and an acquisition sequence of the camera frames, comprises:
obtaining, from the camera frames, a camera frame whose acquisition sequence is the same as the acquisition sequence of the first triggering operation, and in response to that the first capture parameter indicates that the first camera frame needs to meet an image requirement, obtaining whether the camera frame determined meets the image requirement;
in response to that the camera frame determined meets the image requirement, using the camera frame determined as the first camera frame, and in response to that the camera frame determined does not meet the image requirement, acquiring, as the first camera frame, a camera frame that meets the image requirement from camera frames captured after a second time point, wherein the second time point is a capture time point of the camera frame determined; and
using a capture time point of the first camera frame as a third time point, and obtaining the second camera frame from camera frames captured after the third time point, wherein the second triggering operation occurs later than the first triggering operation.

7. The image capture method of claim 2, further comprising:
sequentially storing the first capture parameter and the second capture parameter according to the acquisition sequence of the first triggering operation and the acquisition sequence of the second triggering operation.

8. The image capture method of claim 7, wherein the processing the first camera frame with the first capture parameter to obtain the first image, and processing the second camera frame with the second capture parameter to obtain the second image, comprises:
sequentially reading the first capture parameter and the second capture parameter according to a storage sequence of the first capture parameter and a storage sequence of the second capture parameter; and
processing the first camera frame with the first capture parameter read to obtain the first image, and processing the second camera frame with the second capture parameter read to obtain the second image.

9. An electronic device, comprising:
one or more processor; and
a memory configured to store computer-executable instructions, wherein the computer-executable instructions, when executed, cause the processor to implement an image capture method,
wherein the image capture method comprises:
in response to a first triggering operation on a capture-control element on a first page, capturing a first image and displaying a first thumbnail of the first image on the first page; and
in response to a second triggering operation on the capture-control element on the first page, capturing a second image and displaying a second thumbnail of the second image on the first page, wherein a position of the first thumbnail and a position of the second thumbnail do not overlap at all or partially overlap.

10. The electronic device of claim 9, wherein the image capture method further comprises:
acquiring a first capture parameter corresponding to the first triggering operation and a second capture parameter corresponding to the second triggering operation, and acquiring a plurality of camera frames captured by a camera, wherein the camera frames are original image data captured by the camera through an image sensor;
obtaining a first camera frame corresponding to the first capture parameter and a second camera frame corresponding to the second capture parameter from the camera frames according to an acquisition sequence of the first triggering operation, an acquisition sequence of the second triggering operation and an acquisition sequence of the camera frames; and
processing the first camera frame with the first capture parameter to obtain the first image, and processing the second camera frame with the second capture parameter to obtain the second image.

11. The electronic device of claim 10, wherein the first page is located in a capture application, and the acquiring a first capture parameter corresponding to the first triggering operation and a second capture parameter corresponding to the second triggering operation, comprises:
obtaining the first capture parameter according to first capture setup information on the first page in response to generating the first triggering operation as well as image parameter requirements corresponding to the capture application; and
obtaining the second capture parameter according to second capture setup information on the first page in response generating the second triggering operation as well as the image parameter requirements.

12. The electronic device of claim 10, wherein the acquiring a plurality of camera frames captured by a camera, comprises:
acquiring the camera frames captured by the camera at or after a first time point until the second image is obtained, wherein the first time point is an acquisition time point of the first triggering operation, and the camera continuously captures the camera frames at a set frequency.

13. The electronic device of claim 10, wherein the obtaining a first camera frame corresponding to the first capture parameter and a second camera frame corresponding to the second capture parameter from the camera frames according to an acquisition sequence of the first triggering operation, an acquisition sequence of the second triggering operation and an acquisition sequence of the respective camera frames, comprises:
obtaining a camera frame, whose acquisition sequence is the same as the acquisition sequence of the first triggering operation as the first camera frame from the camera frames; and
obtaining a camera frame, whose acquisition sequence is the same as the acquisition sequence of the second triggering operation as the second camera frame from the camera frames.

14. The electronic device of claim 10, wherein the obtaining a first camera frame corresponding to the first capture parameter and a second camera frame corresponding to the second capture parameter from the camera frames according to an acquisition sequence of the first triggering operation, an acquisition sequence of the second triggering operation and an acquisition sequence of the camera frames, comprises:
obtaining, from the camera frames, a camera frame whose acquisition sequence is the same as the acquisition sequence of the first triggering operation, and in response to that the first capture parameter indicates that the first camera frame needs to meet an image requirement, obtaining whether the camera frame determined meets the image requirement;
in response to that the camera frame determined meets the image requirement, using the camera frame determined as the first camera frame, and in response to that the camera frame determined does not meet the image requirement, acquiring, as the first camera frame, a camera frame that meets the image requirement from camera frames captured after a second time point, wherein the second time point is a capture time point of the camera frame determined; and
using a capture time point of the first camera frame as a third time point, and obtaining the second camera frame from camera frames captured after the third time point, wherein the second triggering operation occurs later than the first triggering operation.

15. The electronic device of claim 10, wherein the image capture method further comprises:
sequentially storing the first capture parameter and the second capture parameter according to the acquisition sequence of the first triggering operation and the acquisition sequence of the second triggering operation.

16. The electronic device of claim 15, wherein the processing the first camera frame with the first capture parameter to obtain the first image, and processing the second camera frame with the second capture parameter to obtain the second image, comprises:
sequentially reading the first capture parameter and the second capture parameter according to a storage sequence of the first capture parameter and a storage sequence of the second capture parameter; and
processing the first camera frame with the first capture parameter read to obtain the first image, and processing the second camera frame with the second capture parameter read to obtain the second image.

17. A non-transitory computer-readable storage medium configured to store computer-executable instructions, wherein the computer-executable instructions, when executed by a processor, implement an image capture method,
wherein the image capture method comprises:
in response to a first triggering operation on a capture-control element on a first page, capturing a first image and displaying a first thumbnail of the first image on the first page; and
in response to a second triggering operation on the capture-control element on the first page, capturing a second image and displaying a second thumbnail of the second image on the first page, wherein a position of the first thumbnail and a position of the second thumbnail do not overlap at all or partially overlap.

18. The non-transitory computer-readable storage medium of claim 17, wherein the image capture method further comprises:
acquiring a first capture parameter corresponding to the first triggering operation and a second capture parameter corresponding to the second triggering operation, and acquiring a plurality of camera frames captured by a camera, wherein the camera frames are original image data captured by the camera through an image sensor;
obtaining a first camera frame corresponding to the first capture parameter and a second camera frame corresponding to the second capture parameter from the camera frames according to an acquisition sequence of the first triggering operation, an acquisition sequence of the second triggering operation and an acquisition sequence of the camera frames; and
processing the first camera frame with the first capture parameter to obtain the first image, and processing the second camera frame with the second capture parameter to obtain the second image.

19. The non-transitory computer-readable storage medium of claim 18, wherein the first page is located in a capture application, and the acquiring a first capture parameter corresponding to the first triggering operation and a second capture parameter corresponding to the second triggering operation, comprises:
obtaining the first capture parameter according to first capture setup information on the first page in response to generating the first triggering operation as well as image parameter requirements corresponding to the capture application; and
obtaining the second capture parameter according to second capture setup information on the first page in response generating the second triggering operation as well as the image parameter requirements.

20. The non-transitory computer-readable storage medium of claim 18, wherein the acquiring a plurality of camera frames captured by a camera, comprises:
acquiring the camera frames captured by the camera at or after a first time point until the second image is obtained, wherein the first time point is an acquisition time point of the first triggering operation, and the camera continuously captures the camera frames at a set frequency.
